(19) United States
(12) Patent Application Publication
(10) Pub. No.: US 2011/0157260 A1
(43) Pub. Date: Jun. 30, 2011

(54) 3D IMAGE DISPLAY DEVICE

(76) Inventors: Jayoung PYUN, Seoul (KR); Kiduk Kim, Gyeonggi-do (KR); Bogun Seo, Gyeonggi-do (KR)

(21) Appl. No.: 12/779,520

(22) Filed: May 13, 2010

(30) Foreign Application Priority Data
Dec. 30, 2009 (KR) 10-2009-0134638
Apr. 2, 2010 (KR) 10-2010-0030382

(51) Int. Cl. G09G 3/36; G09G 5/10

(52) U.S. Cl. 345/691; 349/15; 345/89

(57) ABSTRACT

A 3-dimensional (3D) image display device includes a liquid crystal panel configured to alternately display a left-eye image and a right-eye image in a cycle of unit frame period, a data driving circuit configured to drive data lines of the liquid crystal panel, a gate driving circuit configured to drive gate lines of the liquid crystal panel, a timing controller configured to divide the unit frame period into N sub-frame periods for each of the left-eye image and the right-eye image, where N is an integer equal to or greater than 2, a plurality of light sources configured to generate light to be radiated to the liquid crystal panel, a light source control circuit configured to generate a backlight control signal to control a turn-on time of the plurality of light sources, and a light source driving circuit configured to turn off all the light sources during a first N-1 subframe periods and turn on all the light sources during a last subframe period.

This application claims the benefit of Korean Patent Application No. 10-2009-0134638 filed on Dec. 30, 2009 and Korean Patent Application No. 10-2010-0030382 filed on Apr. 2, 2010, which are hereby incorporated by reference.

### BACKGROUND OF THE INVENTION

1. Field of the Invention

The present invention relates to an image display device, and more particularly to a 3-dimensional image (hereinafter referred to as “3D image”) display device which is capable of increasing the display quality by improving the response time of liquid crystals.

2. Discussion of the Related Art

A 3D image display device implements a 3D image using a stereoscopic technique or an autostereoscopic technique. The 3D image display device uses parallax images of the left and right eyes having a high 3D effect and comprises a stereoscopic technique and an autostereoscopic technique, both of which are being put to practical use. In the autostereoscopic technique, in general, an optical plate, such as a parallax barrier for separating the optical axes of the left and right parallax images, is placed in front or at the rear of a display screen. The stereoscopic technique is used to display the left and right parallax images with different polarization directions on a liquid crystal display panel and to implement a 3D image using polarizing glasses or liquid crystal shutter glasses.

The stereoscopic technique can be classified into a first polarization filter method using a pattern retarder film and polarizing glasses, a second polarization filter method using a switching liquid crystal layer and polarizing glasses, and a shutter glass method using liquid crystal shutter glasses.

The first polarization filter method is used to implement a 3D image by alternately displaying a left-eye image and a right-eye image in a liquid crystal panel for every horizontal line, switching polarization characteristics incident on the polarizing glasses via the pattern retarder film on the liquid crystal panel, and spatially splitting the left-eye image and the right-eye image. The second polarization filter method is used to implement a 3D image by alternately displaying a left-eye image and a right-eye image in a liquid crystal panel on a frame basis, switching polarization characteristics incident on the polarizing glasses via the switching liquid crystal layer on the liquid crystal panel, and temporally and spatially splitting the left-eye image and the right-eye image. In the first and second polarization filter methods, the pattern retarder film or the switching liquid crystal layer disposed on the liquid crystal panel as a polarization filter may adversely affect the transmittance of a 3D image.

The shutter glass method is used to implement a 3D image by alternately displaying a left-eye image and a right-eye image in a liquid crystal panel on a frame by frame basis and opening or shutting the left/right shutters of the liquid crystal shutter glasses in synchronism with the display timing. The liquid crystal shutter glasses, as shown in FIG. 1, generates a binocular parallax in a time-division manner wherein only the left shutter of the liquid crystal shutter glasses is opened during a first frame period Frame1 in which the left-eye image (for example, white W image) is displayed in the liquid crystal panel, and only the right shutter thereof is opened during a second frame period Frame2 in which the right-eye image (for example, black B image) is displayed in the liquid crystal panel.

To produce an excellent binocular parallax by turning on a backlight in the second period Tb of each frame as in the required specification of FIG. 1, the response of the liquid crystals has to be completed within the first period Ta of the corresponding frame. However, the response time of the liquid crystal is not actually completed within the first period Ta, but extends into the second period Tb. Accordingly, the slow response time of the liquid crystal may cause a lower than desirable brightness in the white state and a higher than desirable brightness in the black state. In other words, in the event that the backlight is turned on in the second period Tb, a brightness level lower than a desired brightness level is displayed in the white state because the backlight is turned on before the liquid crystals are subject to rising saturation in the white state. Also, a brightness level higher than a desired brightness level is displayed in the black state because the backlight is turned on before the liquid crystals are subject to falling saturation in the black state. If the backlight is turned on in the period in which the liquid crystals are not fully saturated in white or black, 3D crosstalk is generated in a ghost form.

### SUMMARY OF THE INVENTION

Accordingly, the present invention is directed to 3D image display device that substantially obviates one or more problems due to limitations and disadvantages of the related art.

An aspect of this invention is to provide a 3D image display device which is capable of increasing the display quality by improving the response time of the liquid crystals.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a 3-dimensional (3D) image display device includes a liquid crystal panel configured to alternately display a left-eye image and a right-eye image in a cycle of unit frame period, a data driving circuit configured to drive data lines of the liquid crystal panel, a gate driving circuit configured to drive gate lines of the liquid crystal panel, a timing controller configured to divide the unit frame period into N sub-frame periods for each of the left-eye image and the right-eye image, where N is an integer equal to or greater than 2, a plurality of light sources configured to generate light to be radiated to the liquid crystal panel, a light source control circuit configured to generate a backlight control signal to control a turn-on time of the plurality of light sources, and a light source driving circuit configured to turn off all the light sources during a first N-1 subframe periods and turn on all the light sources during a last subframe period.

In another aspect, a method of driving a 3-dimensional (3D) image display device having a liquid crystal display panel and a plurality of light sources includes alternately displaying a left-eye image and a right-eye image in a cycle of unit frame period, providing light to the liquid crystal display panel with the plurality of light sources, dividing the unit frame period into N sub-frame periods for each of the left-eye image and the right-eye image, generating a backlight control signal to control a turn-on time of the plurality of light sources, and turning off the plurality of light sources during a first N-1 sub-frame periods and turning on the plurality of light sources during the last sub-frame period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating a cause of 3D crosstalk occurring due to a slow liquid crystal response time in a related 3D image display device;

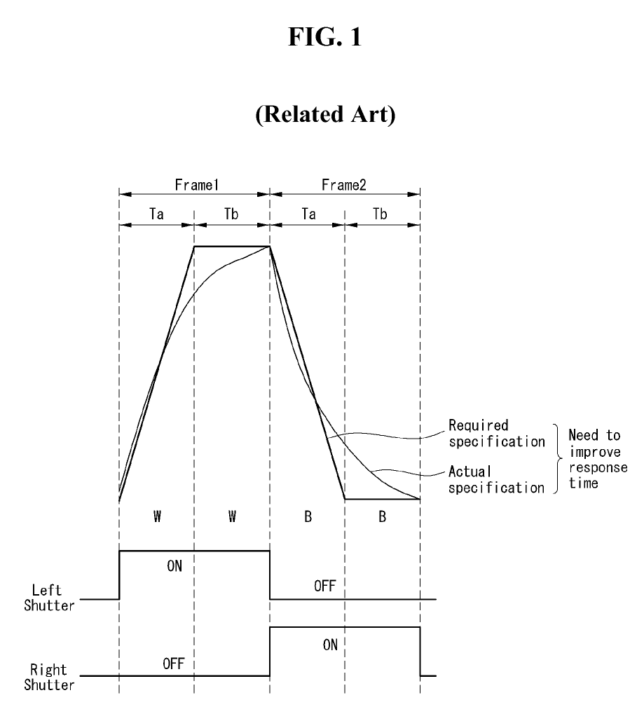

FIG. 2 is a diagram showing a 3D image display device according to an exemplary embodiment of the invention;

FIGS. 3 and 4 are diagrams showing write timings of data, turn-on/off timings of light sources, and opening timings of left/right shutters according to a first exemplary embodiment of the invention;

FIG. 5 is a diagram illustrating an example in which turn-on timings of the light sources are changed according to the duty ratio of a PWM signal according to the first exemplary embodiment of the invention;

FIGS. 6 and 7 show diagrams showing write timings of data, turn-on/off timings of light sources, and opening timings of left/right shutters according to a second exemplary embodiment of the invention;

FIG. 8 is a diagram illustrating an example in which turn-on timings of the light sources are changed according to the duty ratio of a PWM signal according to the second exemplary embodiment of the invention; and

FIG. 9 is a diagram illustrating an example in which the levels of a driving current are controlled according to the duty ratio of a PWM signal in order to compensate for a reduction in brightness.

### DETAILED DESCRIPTION OF THE PREFERRED EMBODIMENTS

Reference will now be made in detail to the preferred embodiments of the present invention, examples of which are illustrated in the accompanying drawings.

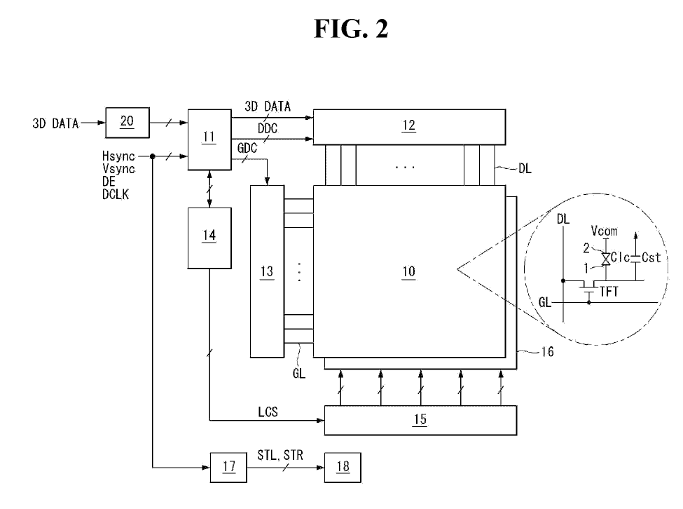

FIG. 2 is a diagram showing a 3D image display device according to an exemplary embodiment of the invention. As shown in FIG. 2, the 3D image display device according to the embodiment of the invention comprises a liquid crystal panel 10, a timing controller 11, a data driving circuit 12, a gate driving circuit 13, a light source control circuit 14, a light source driving circuit 15, a backlight unit 16, a shutter control circuit 17, and shutter glasses 18.

The liquid crystal panel 10 comprises two sheets (i.e., upper and lower) of glass substrates and a liquid crystal layer interposed between the glass substrates. A number of data lines DL and a number of gate lines GL intersect each other in the lower glass substrate of the liquid crystal panel 10. Liquid crystal cells Clc are arranged in a matrix form in the liquid crystal panel 10 by a crossing structure of the data lines DL and the gate lines GL. A thin film transistor (TFT), a storage capacitor Cst and the pixel electrode 1 of each liquid crystal cell Clc which are coupled to the TFT, and so on are further formed in the lower glass substrate of the liquid crystal panel 10.

Black matrices and color filters (not shown) are formed on the upper glass substrate of the liquid crystal panel 10. A common electrode 2 is formed on the upper glass substrate in a vertical electric field driving method, such as a twisted nematic (TN) mode and a vertical alignment (VA) mode. On the other hand, the common electrode 2 is formed on the lower glass substrate along with the pixel electrode 1 in a horizontal electric field driving method, such as an in-plane switching (IPS) mode and a fringe field switching (FFS) mode. A polarization plate is attached to each of the upper and lower glass substrates of the liquid crystal panel 10. An orientation film for determining the pre-tilt angle of a liquid crystal is formed on an inner surface contacting the liquid crystal.

The timing controller 11 generates a data timing control signal DDC to control the operation timing of the data driving circuit 12 and a gate timing control signal GDC to control the operation timing of the gate driving circuit 13 in response to timing signals Vsync, Hsync, DE, and DCLK, which are received from an external system circuit. The timing controller 11 controls the operations of the data driving circuit 12 and the gate driving circuit 13 in the sub-frame frequency of (unit frame frequency×N) Hz, where N is a positive integer equal to or greater than 2, by multiplying the data timing control signal DDC and the gate timing control signal GDC. For example, the sub-frame frequency is 240 Hz when the unit frame frequency is 120 and N is 2.

The timing controller 11 performs time division on one frame period into N subframe periods. The timing controller 11 copies unit frame data 3D DATA of a 3D data format, received from the external system circuit, to a frame memory on a frame by frame basis. The timing controller 11 repeatedly supplies data displayed when the left shutter of the shutter glasses 18 is open (hereinafter referred to as “left-eye data”) to the data driving circuit 12 during the N subframe periods of an odd frame. The timing controller 11 repeatedly supplies data displayed when the right shutter of the shutter glasses 18 is open (hereinafter referred to as “right-eye data”) to the data driving circuit 12 during the N subframe periods of an even frame.

The data driving circuit 12 comprises a number of data drive integrated circuits (ICs). Each of the data drive ICs comprises a shift register, a register, a latch, a digital to analog (D/A) converter, a multiplexer, and an output buffer. The shift register samples a clock signal. The register temporarily stores digital data received from the timing controller 11. The latch stores data for every one line in response to a clock signal generated by the shift register and outputs the data of one line unit at a time. The D/A converter selects a gamma voltage of the positive or negative polarity with reference to a gamma reference voltage in response to the digital data value output from the latch. The multiplexer selects the data lines DL along which analog data converted in response to the positive polarity or negative polarity gamma voltage are supplied. The output buffer is coupled between the multiplexer and the data lines DL. The data driving circuit 12 converts the left eye/right-eye data of a 3D data format into an analog data voltage in response to the data timing control signal DDC of the sub-frame frequency (unit frame frequency×N) Hz and supplies the same data to the data lines DL N times within each frame.

The gate driving circuit 13 comprises a number of gate drive ICs. Each of the gate drive ICs comprises a shift register, a level shifter for converting the output signal of the shift register according to a swing width suitable to drive the TFTs of the liquid crystal cells, and an output buffer. The gate driving circuit 13 sequentially outputs scan pulses or gate pulses in response to the gate timing control signal GDC of the sub-frame frequency (unit frame frequency×N) Hz and supplies them to the gate lines GL twice within each frame.

The backlight unit 16 comprises a number of light sources and radiates light to the liquid crystal panel 10. The backlight unit 16 may be implemented using a direct type backlight unit or an edge type backlight unit. The direct type backlight unit 16 has a structure in which a number of optical sheets and a diffusion sheet are stacked under the liquid crystal panel 10 and a number of the light sources are disposed under the diffusion sheet. The edge type backlight unit 16 has a structure in which a number of optical sheets and a light guide plate are stacked under the liquid crystal panel 10 and one or more of the light sources are disposed on the side of the light guide plate. The light sources may be implemented as a cold cathode fluorescent lamp (CCFL), an external electrode fluorescent lamp (EEFL), dot light sources such as a light emitting diode (LED), or any other suitable lamp or light emitting device.

The light source control circuit 14 generates a light source control signal LCS under the control of the timing controller 11 and controls the light sources according to the backlight control signal, e.g., a pulse width modulation (PWM) signal, pulse amplitude modulation (PAM) signal, pulse frequency modulation (PFM) signal, so that the light sources are blinked at the same time in response to the light source control signal LCS. The light source control signal LCS includes a PWM signal for controlling the turn-on time of the light sources and a current control signal for controlling the driving current of the light sources. A maximum duty ratio of a PWM signal may be set to 50% or less in order to improve the performance of 3D cross-talk and a motion picture response time (MPRT). A level of the driving current of the light sources may be set, so that the level of the driving current is inversely proportional to the maximum duty ratio of the PWM signal by the current control signal. More specifically, as the maximum duty ratio of the PWM signal decreases, the level of the driving current increases. The inversely proportional relationship between the maximum duty ratio of the PWM signal and the level of the driving current is to compensate for a reduction in luminance of the screen resulting from an increase in turn-off time of the light sources in one frame period for improving the MPRT performance. A duty ratio of the PWM signal may vary depending on the input image within a range equal to or less than the previously set maximum duty ratio. In this case, the light source control circuit 14 analyzes the input image and adjusts the duty ratio of the PWM signal according to the analysis result of the input image. The light source control circuit 14 may be built in the timing controller 11.

The light source control signal LCS comprises turn-on/off timings of the light sources. The turn-on timing of the light sources may vary depending on the duty ratio of a PWM signal after the liquid crystals are saturated. The turn-off timing of the light sources may be fixed to a point of time at which the left/right-eye data of a next frame are written at the center of the liquid crystal panel 10. The light source driving circuit 15 blinks the light sources by turning off all the light sources during the first N-1 subframe period and turning on all the light sources during the last subframe period, in response to the light source control signal LCS.

The shutter control circuit 17 determines whether a current frame is an odd frame in which the left-eye data will be displayed or an even frame in which the right-eye data will be displayed based on the vertical sync signal Vsync received from the external system circuit. The shutter control circuit 17 generates a left shutter control signal STL to open the left shutter of the shutter glasses 18 during the odd frames and a right shutter control signal STR to open the right shutter of the shutter glasses 18 during the even frames.

The shutter glasses 18 is an apparatus to be worn by a viewer who wants to see left/right-eye images in three-dimensions, displayed in the liquid crystal panel 10 on a frame by frame basis. The shutter glasses 18 alternately open and shut the left and right shutters on a frame by frame basis in response to the shutter control signals STL and STR generated by the shutter control circuit 17. As the left/right-eye images are alternately shut off, different images are formed in the left and right eyes of the shutter glasses 18. Accordingly, a viewer can have a feeling of viewing a 3D image.

The data modulation circuit 20 is configured to modulate the unit frame frequency to prevent flickering. In particular, the data modulation circuit 20 inserts interpolation frames into the input frame data provided from the video source to generate a unit frame data. For example, the data modulation circuit 20 can modulate the input frame data with a frequency of 60 Hz into a unit frame data with a unit frame frequency of 120 Hz by inserting one interpolation frame for each input frame data. Alternatively, the data modulation circuit 20 can modulate the input frame data with a frequency of 60 Hz into a unit frame data with a unit frame frequency of 80 Hz by inserting one interpolation frame for every three input frame data. The data modulation circuit 20 then provides the unit frame data to the timing controller 11. The data modulation circuit 20 can be formed within an external system circuit (not shown).

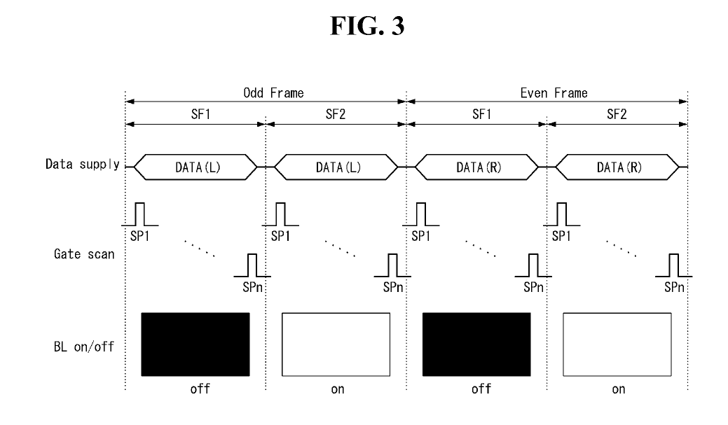

FIGS. 3 to 5 show data writing, turn-on/off timings of the light sources, and open timings of the left/right shutters for the purpose of improving the display quality according to a first exemplary embodiment of the present invention wherein the unit frame frequency is set to be 120 Hz.

As shown in FIGS. 3 and 4, when the unit frame frequency is 120 Hz, a unit frame is divided into a first subframe SF1 and a second subframe SF2 in the time-division manner. Then, the same unit frame data is provided to the data driving circuit during the first and second subframe periods SF1 and SF2 after unit frame data is copied. Accordingly, the timing controller controls the gate driving circuit and the data driving circuit with a sub-frame frequency of 240 Hz.

During the first and second subframes SF1 and SF2 of an odd frame, left-eye data DATA (L) for one frame are redundantly displayed in the liquid crystal panel 10. Further, during the first and second subframes SF1 and SF2 of an even frame, right-eye data DATA (R) for one frame are redundantly displayed in the liquid crystal panel 10. The response time of a liquid crystal LC is inversely proportional to the capacitor components existing in the liquid crystal panel. The capacitance of the capacitor components is inversely proportional to the frame frequency. Accordingly, when the unit frame frequency is multiplied by two as compared with the input frame frequency, the response time of the liquid crystal LC can become faster correspondingly. Accordingly, in the odd frame, before a lapse of time corresponding to the first subframe SF1 immediately after the left-eye data DATA (L) are written at the center of the liquid crystal panel 10, the liquid crystal LC at the center of the liquid crystal panel 10 is saturated and maintained at the saturation state throughout the second subframe SF2 of the odd frame. In the odd frame, all the light sources BL are simultaneously turned on at the maximum duty ratio of 50% or less during the second subframe SF2 in which the central liquid crystal LC is maintained at the saturation state. Further, the left shutter of the shutter glasses 18 is open during the odd frame period.

Meanwhile, in the even frame, before a lapse of time corresponding to the first subframe SF1 immediately after the right-eye data DATA (R) is written at the center of the liquid crystal panel 10, a liquid crystal LC at the center of the liquid crystal panel 10 is saturated and maintained at the saturation state throughout the second subframe SF2 of the even frame. In the even frame, all the light sources BL are simultaneously turned on at the maximum duty ratio of 50% or less during the second subframe SF2 in which the central liquid crystal LC is maintained at the saturation state. Further, the right shutter of the shutter glasses 18 is open during the even frame period.

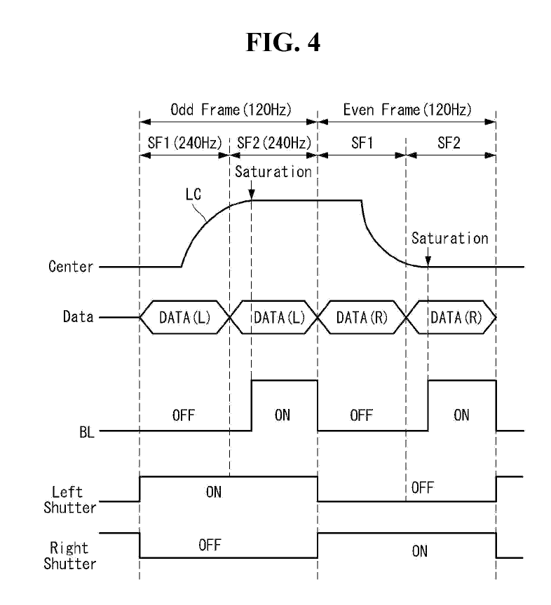

The turn-on timing of the light sources BL, as shown in FIG. 5, can be differently determined based on the maximum duty ratio of a PWM signal. For example, the turn-on timing of the light sources BL can be a first point of time t1 in order to implement the maximum duty ratio of 50% or be a second point of time t2, which is later than the first point of time t1, in order to implement the maximum duty ratio of less than 50%.

3D cross-talk can be reduced by improving the response time of the liquid crystal display panel using the first embodiment shown in FIGS. 3-5. Nevertheless, the liquid crystal cells in the lower portion of the liquid crystal display panel can still remain in a transition state while the liquid crystal cells in the middle portion of the liquid crystal display panel are in a saturated state because the liquid crystal cells in the lower portion respond to data that is input at a time later than that of the middle portion of the liquid crystal display panel. This is because the turn-on time is determined based on the middle portion of the liquid crystal display panel and because the unit frame period is relatively short, e.g., 1/120 seconds when the unit frame frequency is 120 Hz. In order to reduce 3D cross-talk at all portions of the liquid crystal display panel, a longer period must be set aside for all liquid crystal cells, including the cells in the lower portion of the liquid crystal display panel, to become saturated.

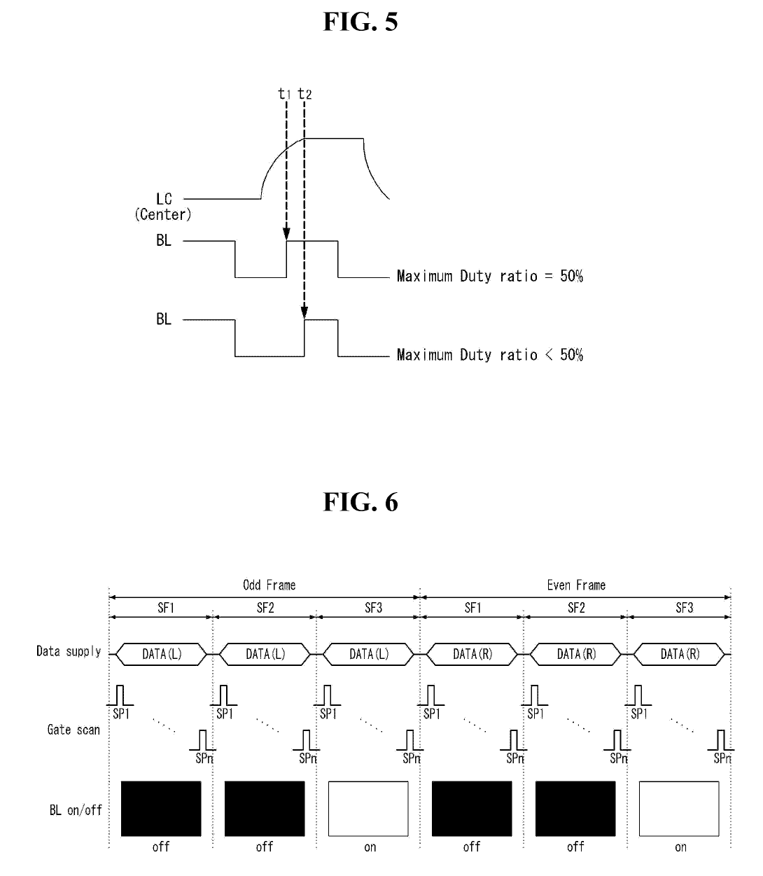

FIGS. 6-8 show diagrams showing write timings of data, turn-on/off timings of light sources, and opening timings of left/right shutters according to a second exemplary embodiment of the invention.

As shown in FIGS. 6 and 7, when the unit frame frequency is 80 Hz, a unit frame is divided into a first subframe SF1, a second subframe SF2, and a third subframe SF3 in the time-division manner. Then, the same unit frame data is provided to the data driving circuit during the first, second, and third subframe periods (SF1, SF2, and SF3) after unit frame data is copied. Accordingly, the timing controller controls the gate driving circuit and the data driving circuit with a sub-frame frequency of 240 Hz, i.e., 80×3 Hz.

During the first, second, and third subframe periods (SF1, SF2, and SF3) of an odd frame, left-eye data DATA (L) for one frame is redundantly displayed in the liquid crystal panel 10. Further, during the first, second, and third subframe periods (SF1, SF2, and SF3) of an even frame, right-eye data DATA (R) for one frame is redundantly displayed in the liquid crystal panel 10. The response time of a liquid crystal LC is inversely proportional to the capacitor components existing in the liquid crystal panel. The capacitance of the capacitor components is inversely proportional to the frame frequency. Accordingly, when the unit frame frequency is multiplied by three as compared with the input frame frequency, the response time of the liquid crystal LC can become faster correspondingly. Accordingly, in the odd frame, before a lapse of time corresponding to the first subframe SF1 immediately after the left-eye data DATA (L) is written at the center of the liquid crystal panel 10, the liquid crystal LC at the center of the liquid crystal panel 10 is saturated and maintained at the saturation state throughout the second and third subframes SF2 and SF3 of the odd frame. Further, the left shutter of the shutter glasses 18 is open during the odd frame period.

Meanwhile, in the even frame, before a lapse of time corresponding to the first subframe SF1 immediately after the right-eye data DATA (R) is written at the center of the liquid crystal panel 10, a liquid crystal LC at the center of the liquid crystal panel 10 is saturated and maintained at the saturation state throughout the second and third subframes SF2 and SF3 of the even frame. Further, the right shutter of the shutter glasses 18 is open during the even frame period.

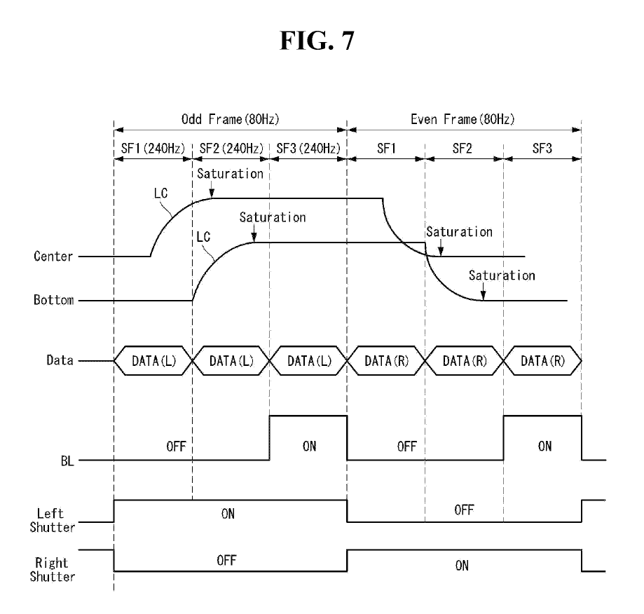

The turn-on timing of the light sources BL, as shown in FIG. 8, can be differently determined based on the maximum duty ratio of a PWM signal. For example, the turn-on timing of the light sources BL can be a first point of time t1 in order to implement the maximum duty ratio of 33% or be a second point of time t2, which is later than the first point of time t1, in order to implement the maximum duty ratio of less than 33%.

3D cross-talk can be reduced by improving the response time of the liquid crystal display panel using the second embodiment shown in FIGS. 6-8. Accordingly, even if the turn-on time is determined based on the middle portion of the liquid crystal display panel, 3D cross-talk can be eliminated in all portions of the liquid crystal display panel. This is because the unit frame period is relatively long, i.e., 1/80 seconds, which provides a longer period for all liquid crystal cells, including the cells in the lower portion of the liquid crystal display panel, to become saturated.

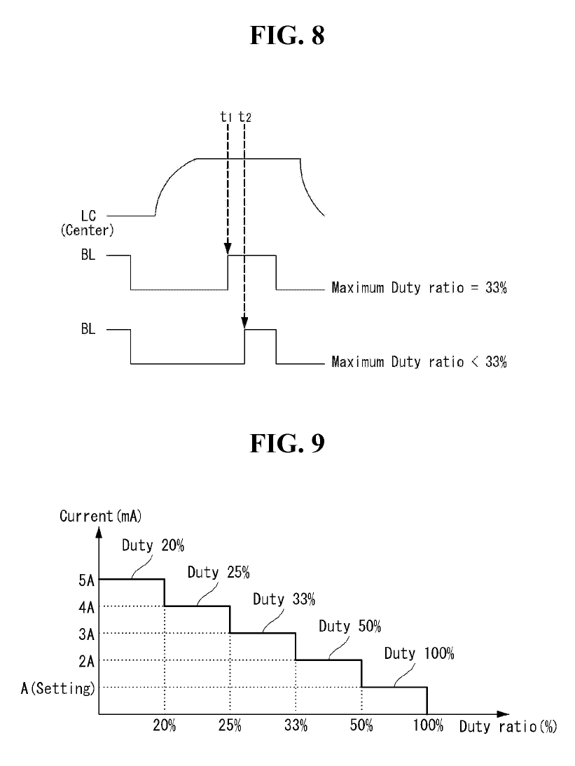

FIG. 9 is a diagram illustrating an example in which the levels of a driving current are controlled according to the duty ratio of a PWM signal in order to compensate for a reduction in brightness. As shown in FIG. 9, the level of the driving current is inversely proportional to the maximum duty ratio of the PWM signal. For example, when the reference current level A is defined to be the current level when maximum duty ratio of the PWM is 100%, the level of the driving current may be set at a value (i.e., 2 A) corresponding to two times the reference current level A when the maximum duty ratio of the PWM signal is 50%; a value (i.e., 3 A) corresponding to three times the reference current level A when the maximum duty ratio of the PWM signal is 33%; a value (i.e., 4 A) corresponding to four times the reference current level A when the maximum duty ratio of the PWM signal is 25%; and a value (i.e., 5 A) corresponding to five times the reference current level A when the maximum duty ratio of the PWM signal is 20%. In FIG. 9, the reference current level A, which is the current level corresponding to a 100% maximum duty ratio of the PWM signal, may be stored in a specific register of the light source control circuit 14.

As described above, the 3D image display device according to this invention controls the operations of the driving circuits at a frequency faster than an input frame frequency, divides one frame into N subframes, and repeatedly displays the same, so that all the liquid crystals are saturated. Further, all the light sources are turned off during the first N-1 subframes, all the light sources are turned on during the last subframe period, and the left and right shutters are alternately opened or shut on a unit frame by unit frame basis. Further, raising a light source driving current can compensate for potential deterioration of the brightness of a display surface resulting from blinking driving. Further, the 3D image display device of this invention can prevent 3D crosstalk by increasing the response time of liquid crystals and improve the performance of an MPRT without causing deterioration of the brightness of motion pictures, thereby significantly improving the display quality.

It will be apparent to those skilled in the art that various modifications and variations can be made in the 3D image display device of the present invention without departing from the spirit or scope of the invention. Thus, it is intended that the present invention cover the modifications and variations of this invention provided they come within the scope of the appended claims and their equivalents.

What is claimed is:

1. A 3-dimensional (3D) image display device, comprising:
a liquid crystal panel configured to alternately display a left-eye image and a right-eye image in a cycle of unit frame period;
a data driving circuit configured to drive data lines of the liquid crystal panel;
a gate driving circuit configured to drive gate lines of the liquid crystal panel;
a timing controller configured to divide the unit frame period into N sub-frame periods for each of the left-eye image and the right-eye image, where N is an integer equal to or greater than 2;
a plurality of light sources configured to generate light to be radiated to the liquid crystal panel;
a light source control circuit configured to generate a backlight control signal to control a turn-on time of the plurality of light sources; and
a light source driving circuit configured to turn off all the light sources during a first N-1 subframe periods and turn on all the light sources during a last subframe period.

2. The 3D image display device in claim 1, wherein the backlight control signal is at least one of a pulse width modulation (PWM) signal, pulse amplitude modulation (PAM) signal, and pulse frequency modulation (PFM) signal.

3. The 3D image display device in claim 1, wherein the timing controller controls an operation timing of the data driving circuit and the gate driving circuit using a sub-frame frequency of (unit frame frequency×N), wherein N is a number of sub-frames equal to or greater than 2.

4. The 3D image display device in claim 3, wherein the unit frame frequency is 120 Hz when N is 2.

5. The 3D image display device in claim 3, wherein the unit frame frequency is 80 Hz when N is 3.

6. The 3D image display device in claim 1, wherein a unit frame data is provided to the data driving circuit during a first sub-frame period and a copied data is provided to the data driving circuit during a second sub-frame period.

7. The 3D image display device in claim 1, wherein a level of a driving current driving the plurality of light sources is inversely proportional to a maximum duty ratio of the backlight control signal output from the light source control circuit.

8. The 3D image display device in claim 1, wherein the turn-on time of the plurality of light sources is delayed as a maximum duty ratio of the backlight control signal decreases.

9. The 3D image display device in claim 1, wherein the turn-on time of the plurality of light sources is determined based on a time at which liquid crystals in a middle portion of the liquid crystal display panel are saturated.

10. The 3D image display device in claim 1, wherein
the timing controller supplies a left-eye data to the data driving circuit during the subframe periods of an odd frame when a left shutter of shutter glasses is open, and
the timing controller supplies a right-eye data to the data driving circuit during the subframe periods of an even frame when a right shutter of shutter glasses is open.

11. The 3D image display device in claim 1, wherein
the timing controller supplies a left-eye data to the data driving circuit during the subframe periods of an even frame when a left shutter of shutter glasses is open, and
the timing controller supplies a right-eye data to the data driving circuit during the subframe periods of an odd frame when a right shutter of shutter glasses is open.

12. The 3D image display device in claim 1, further comprising a shutter control circuit configured to determine whether a current frame is an odd frame in which the left-eye image is to be displayed or an even frame in which the right-eye image is to be displayed.

13. The 3D image display device in claim 1, further comprising a shutter control circuit configured to determine whether a current frame is an odd frame in which the right-eye image is to be displayed or an even frame in which the left-eye image is to be displayed.

14. The 3D image display device in claim 1, wherein a unit frame data is provided to the data driving circuit during a first sub-frame period and a copied data is provided to the data driving circuit during a second sub-frame period and a third sub-frame period.

15. A method of driving a 3-dimensional (3D) image display device having a liquid crystal display panel and a plurality of light sources, comprising:
alternately displaying a left-eye image and a right-eye image in a cycle of unit frame period;
providing light to the liquid crystal display panel with the plurality of light sources;
dividing the unit frame period into N sub-frame periods for each of the left-eye image and the right-eye image;
generating a backlight control signal to control a turn-on time of the plurality of light sources; and
turning off the plurality of light sources during a first N-1 sub-frame periods and turning on the plurality of light sources during a last sub-frame period.

16. The method in claim 15, wherein a level of a driving current driving the plurality of light sources is inversely proportional to a maximum duty ratio of the backlight control signal.

17. The method in claim 15, wherein the turn-on time of the plurality of light sources is delayed as a maximum duty ratio of the backlight control signal decreases.

18. The method in claim 15, wherein the turn-on time of the plurality of light sources is determined based on a time at which liquid crystals in a middle portion of the liquid crystal display panel are saturated.

19. The method in claim 15, wherein the plurality of light sources are simultaneously turned on after liquid crystals in the middle portion of the liquid crystal display panel are saturated.

20. The method in claim 15, further comprising:
supplying a left-eye data to generate the left-eye image during the N subframe periods of an odd frame, and
supplying a right-eye data to generate the right-eye image during the N subframe periods of an even frame.

21. The method in claim 15, further comprising:
supplying a left-eye data to generate the left-eye image during the N subframe periods of an even frame, and
supplying a right-eye data to generate the right-eye image during the N subframe periods of an odd frame.

22. The method in claim 15, further comprising determining whether a current frame is an odd frame in which the left-eye image is to be displayed or an even frame in which the right-eye image is to be displayed.

23. The method in claim 15, further comprising determining whether a current frame is an odd frame in which the right-eye image is to be displayed or an even frame in which the left-eye image is to be displayed.

24. The method in claim 15, wherein the backlight control signal is at least one of a pulse width modulation (PWM) signal, pulse amplitude modulation (PAM) signal, and pulse frequency modulation (PFM) signal.

25. The method in claim 15, wherein a sub-frame frequency is (unit frame frequency×N), wherein N is a number of sub-frames equal to or greater than 2.

26. The method in claim 25, wherein the unit frame frequency is 120 Hz when N is 2.

27. The method in claim 25, wherein the unit frame frequency is 80 Hz when N is 3.
